(19) United States
(12) Patent Application Publication
(10) Pub. No.: US 2012/0177938 A1
(43) Pub. Date: Jul. 12, 2012

(54) METALWORKING FLUID, METAL WORKING METHOD AND METAL WORK PRODUCT

(75) Inventors: Koichi Goto, Fujisawa-shi (JP); Satoshi Mima, Fujisawa-shi (JP); Yoshihiko Machida, Fujisawa-shi (JP)

(73) Assignee: KYODO YUSHI CO., LTD., Fujisawa-shi, Kanagawa (JP)

(21) Appl. No.: 13/496,558

(22) PCT Filed: Sep. 17, 2010
(86) PCT No.: PCT/JP2010/066203

§ 371 Date: Mar. 16, 2012

(30) Foreign Application Priority Data
Sep. 18, 2009 (JP) 2009-217563

(51) Int. Cl. C10M 105/34; B32B 15/01; B24B 1/00; B23P 17/04; B26D 7/08

(52) U.S. Cl. 428/544; 508/463; 29/592; 83/22; 451/54

(57) ABSTRACT

The invention provides a metalworking fluid which contains (A) a base oil including 2-ethylhexanol palmitate or 2-ethylhexanol stearate, and (B) an anionic surfactant that is a salt of a branched aliphatic carboxylic acid having 8 to 18 carbon atoms with a branched alkanolamine having 3 to 12 carbon atoms. The metalworking fluid of the invention is excellent in the cutting performance, anti-foaming properties, stability of stock solution, emulsion stability and resistance to hydrolysis, and shows low kinematic viscosity at low temperatures.

### TECHNICAL FIELD

The present invention relates to a metalworking fluid applicable to a wide range of metal working, such as cutting, grinding, rolling, pressing, plastic working and the like. More specifically, the invention relates to a metalworking fluid which is used after diluted with water, in particular, having excellent cutting performance, a metal working method using the above-mentioned metalworking fluid, and a metal work product obtainable by the above-mentioned metal working method.

### BACKGROUND ART

Generally, a cutting oil or grinding oil is used for cutting or grinding operation. The most important function of the cutting oil or grinding oil is considered to be a lubricating action, which can extend the life of tools used for the processing, improve the accuracy of finished surface of a product subjected to processing, increase the production efficiency and the like, thereby leading to the improvement of productivity. Some approaches have been taken to meet the above-mentioned requirements from the aspect of the processing method. As for the supply of coolant, internal supply system has become conspicuous. The internal coolant supply system necessarily places the coolant under high pressure while in use, which accompanies the problem of bubbling. In light of this, oils with excellent anti-foaming properties are also desired.

As the measure to improve the lubricating action, for example, a hot rolling oil comprising a particular palm olein and a hot rolling method are disclosed (JP 3320642 B); a lubricating oil composition with excellent resistance to hydrolysis used for rolling or cutting, comprising as the essential ingredients a base oil comprising an animal or vegetable oil such as palm oil and the modified fats and oils thereof (palm fractionated oil or the like), and a synthetic hydrocarbon oil is known (JP 10-17880 A).

In addition, there is known a metalworking fluid comprising a lubricating oil component selected from the group consisting of fats and oils, mineral oils and fatty acid esters, a particular cationic or amphoteric water-soluble polymeric compound, and a nonionic surfactant (JP 02-40116 B).

However, those metalworking fluids have some drawbacks, i.e., insufficient lubricating action, poor anti-foaming properties, susceptibility to hydrolysis, and the like.

### SUMMARY OF INVENTION

### Technical Problem

An object of the invention is to provide a metalworking fluid applicable to a wide range of metal working, such as cutting, grinding, rolling, pressing, plastic working and the like.

Another object is to provide a metalworking fluid excellent in cutting performance.

A further object of the invention is to provide a metalworking fluid that is excellent in the cutting performance, anti-foaming properties, stability of the stock solution, emulsion stability, and resistance to hydrolysis, and has low kinematic viscosity at low temperatures.

A still another object of the invention is to provide a metal working method using the above-mentioned metalworking fluid, and a metal work product obtainable by the above-mentioned metal working method.

### Solution to Problem

As a result of extensive studies, the inventors of the present invention found that use of a particular aliphatic carboxylic acid ester and a particular surfactant can generate a metalworking fluid that is much superior to the conventional metalworking fluids in terms of cutting performance, anti-foaming properties, and resistance to hydrolysis. The invention has been accomplished based on the above-mentioned findings. The invention provides a metalworking fluid, a metal working method using the metalworking fluid, and a metal work product obtainable by the metal working method as shown below.

(1) A metalworking fluid comprising a base oil and an anionic surfactant, wherein the base oil comprises an aliphatic carboxylic acid ester with 2-ethylhexanol and the aliphatic carboxylic acid is at least one selected from the group consisting of palmitic acid and stearic acid; and the anionic surfactant is an aliphatic carboxylic acid amine salt and the aliphatic carboxylic acid for constituting the aliphatic carboxylic acid amine salt comprises at least one selected from branched aliphatic carboxylic acids having 8 to 18 carbon atoms, and the amine for constituting the aliphatic carboxylic acid amine salt comprises at least one selected from branched alkanolamines having 3 to 12 carbon atoms.

(2) The metalworking fluid described in the above-mentioned (1), wherein the aliphatic carboxylic acid ester with 2-ethylhexanol is contained in an amount of 0.5 to 15 mass % in the fluid.

(3) The metalworking fluid described in the above-mentioned (1) or (2), wherein the anionic surfactant is contained in an amount of 0.05 to 80 mass % in the fluid.

(4) The metalworking fluid described in any one of the above-mentioned (1) to (3), which is used as a stock solution or used after diluted with water at a concentration of 0.1 mass % or more.

(5) The metalworking fluid described in any one of the above-mentioned (1) to (4), which is a cutting oil or grinding oil.

(6) A metal working method for processing metals, compsiring using the metalworking fluid described in any one of the above-mentioned (1) to (5).

(7) The metal working method described in the above-mentioned (6), which is for cutting or grinding.

(8) A metal work product obtainable by the metal working method described in the above-mentioned (6) or (7).

### Effects of Invention

The metalworking fluid of the invention uses a particular aliphatic carboxylic acid ester and a particular surfactant in combination. As a result, the metal workability, in particular, the cutting performance can be significantly improved when compared with the case where the conventional metalworking fluids are employed. Therefore, the tool life can be extended to reduce the cost. Also, the number of operations for changing the tools can be decreased to enhance the productivity. By taking advantage of the improved cutting performance, the metalworking fluid of the invention can be widely used when a metallic material is subjected to cutting, grinding, rolling, pressing, plastic working and the like.

Further, use of an anionic surfactant composed of a branched aliphatic carboxylic acid and a branched amine as the surfactant can improve not only the cutting performance, but also the anti-foaming properties, and therefore the leakage of oil due to bubbling can be prevented more effectively when compared with the case where the conventional metalworking fluids are used. This can ensure the operator's safety and improve the operating environment.

The metalworking fluid of the invention is also excellent in the stability of the stock solution, emulsion stability, and resistance to hydrolysis. In addition, due to the low kinematic viscosity at low temperatures, the oil pumpability is satisfactory even during winter season.

### DESCRIPTION OF EMBODIMENTS

Examples of the base oil used in the invention include mineral oils, polyol esters, fats and oils, polyglycols, poly α-olefins, normal paraffins, isoparaffins, alkyl benzenes, polyethers and the like. Those may be used alone or in combination to form a blend oil. In particular, mineral oils, polyglycols and alkyl benzenes are preferable.

The base oil of the invention comprises an ester of an aliphatic carboxylic acid with 2-ethylhexanol, i.e., at least one selected from the group consisting of an ester of palmitic acid with 2-ethylhexanol and an ester of stearic acid with 2-ethylhexanol (hereinafter referred to as aliphatic carboxylic acid ester with 2-ethylhexanol).

The metalworking fluid according to the invention (it refers to “stock solution” before diluted with water. The same applies hereinafter, unless otherwise specified) comprises preferably 1 to 95 mass %, more preferably 3 to 95 mass % of the base oil.

The aliphatic carboxylic acid ester with 2-ethylhexanol may preferably be contained in an amount of 0.5 to 15 mass %, more preferably 1 to 15 mass %, in the metalworking fluid of the invention.

With a content of the aliphatic carboxylic acid ester of less than 0.5 mass %, the improvement in the cutting performance will be insufficient. The content of more than 15 mass % is uneconomical because a further effect cannot be expected.

The anionic surfactant used in the metalworking fluid of the invention is an aliphatic carboxylic acid amine salt. The aliphatic carboxylic acid for constituting the aliphatic carboxylic acid amine salt comprises at least one selected from branched aliphatic carboxylic acids having 8 to 18 carbon atoms, and the amine comprises at least one selected from branched alkanolamines having 3 to 12 carbon atoms.

Specific examples of the branched aliphatic carboxylic acid include 2-ethylhexanoic acid, isooctanoic acid, isononanoic acid, isodecanoic acid, neodecanoic acid, isostearic acid and the like.

Specific examples of the branched alkanolamine having 3 to 12 carbon atoms include monoisopropanolamine, diisopropanolamine, triisopropanolamine, n-butyl mono isopropanolamine, n-butyl diisopropanolamine, di-n-butyl monoisopropanolamine, t-butyl monoisopropanolamine, t-butyl diisopropanolamine, di-t-butyl monoisopropanolamine and the like.

Desirably, the metalworking fluid of the invention may further comprise an oil-soluble aliphatic carboxylic acid and an oil-soluble amine to control the stock solution stability and the emulsion stability of the fluid.

As the oil-soluble aliphatic carboxylic acid, ricinoleic acid condensate, octanoic acid, nonanoic acid, decanoic acid, undecanoic acid, undecylenic acid, dodecanoic acid, tridecanoic acid, pentadecanoic acid, heptadecanoic acid, myristic acid, palmitic acid, stearic acid, linolic acid, oleic acid and the like can be used. The oil-soluble aliphatic carboxylic acid may preferably be contained in an amount of 2.5 to 60 mass %, more preferably 5 to 50 mass %, with respect to the total mass of the fluid (as the stock solution).

Examples of the oil-soluble amine include dicyclohexylamine, cyclohexylamine cyclohexylpropylenediamine, dibutylethanolamine, dibenzylamine and the like. The oil-soluble amine may preferably be contained in an amount of 0.5 to 10 mass %, more preferably 1 to 10 mass %, with respect to the total mass of the fluid (as the stock solution).

The fluid (as the stock solution) may preferably have an acid value of 2 to 80, more preferably 5 to 40; and preferably have an amine value of 10 to 150, more preferably 20 to 110.

The acid value is the mass of potassium hydroxide in milligrams that is required to neutralize one gram of a sample (according to the indicator titration method of JIS K 2501). The amine value is the mass of potassium hydroxide in milligrams equivalent to hydrochloric acid that is required to neutralize one gram of a sample (according to the potentiometric titration method of JIS K 2501).

The fluid may appropriately be adjusted to preferably pH7.0 to 11.0, more preferably pH8.0 to 11.0 when diluted with pure water at a concentration of 3 mass %.

In the fluid of the invention, the content of the aliphatic carboxylic acid amine salt used as the anionic surfactant may preferably be in the range of 0.05 to 80 mass %, more preferably 5 to 70 mass %, with respect to the total mass of the fluid. When the above-mentioned content is less than 0.05 mass %, the improvement in the cutting performance will be insufficient; and when the content exceeds 80 mass %, the anti-foaming properties tend to decrease.

In order to ensure the good low-temperature properties, the kinematic viscosity (at 5° C. in accordance with JIS K 2283) of the metalworking fluid according to the invention may preferably be 1500 mm²/s or less, more preferably 1000 mm²/s or less.

The fluid (stock solution) of the invention may further comprise water in addition to the above-mentioned components from the viewpoint of prevention of ignition. The water may be added to such a degree that it will become impossible to reach the flash point, for example, in an amount of 3 mass % or more. The content of water may also be preferably 50 mass % or less from the viewpoint of transportation cost.

To the metalworking fluid of the invention, an anti-foaming agent and other additives (e.g., an extreme-pressure agent, corrosion inhibitor, viscosity index improver, antioxidant, detergent-dispersant, coloring agent, perfume and the like) may appropriately be added.

The metalworking fluid of the invention may be any of an emulsion type, soluble type, or solution type.

When the metalworking fluid of the invention, e.g., a cutting oil or a grinding oil is used for processing of metals, the fluid may be used as it is (as the stock solution), or the fluid may preferably be diluted with water at concentrations of 0.1 to 60 mass %, more preferably 0.1 to 30 mass %, and most preferably 1.0 to 20 mass %.

A proper amount of the diluted solution may be continuously or intermittently applied to the tool and/or the surface of a workpiece according to the conventional method.

The tools which are used for the operation involving use of the fluid according to the invention include those of carbon steel, alloy steel, high-speed steel, cast steel, carbide, cermet, ceramic, cubic boron nitride, diamond and the like. To improve the wear resistance, the tools may be subjected to surface heat treatment such as carburizing, nitriding, oxidizing or the like; or surface coating with TiC, TiN, TiCN, Al₂O₃, diamond-like carbon or the like.

Examples of the workpiece include steel materials such as rolled steels for general structure, carbon steels for machine structural use, carbon steel forgings, carbon steel castings, alloy steels for machine structural use, alloy tool steels and the like; and non-ferrous metals such as copper, aluminum and the like.

### EXAMPLES

Tables 1 to 4 show metalworking fluids according to the examples and comparative examples. The following testing methods were used to evaluate the performance of each of the metalworking fluids. The results are also shown in Tables 1 to 4.

In Tables, the numerical value in each column showing the component represents a percentage by mass of the component in the stock solution of metalworking fluid.

### Test for Cutting Performance

Using the following workpiece material, tapping was conducted to cut a thread with a diameter of 6 mm under the conditions shown below. The cutting resistance during cutting operation was determined.
Tool: B-NRT RH7 M6×1.0 made by OSG Corporation
Workpiece material: AC8B-T6
Cutting speed: 10 m/min.
Feed rate/rev.: 1.0 mm/rev.
Tap drill size of pilot hole: 5.48 mm, finished with reamer, blind hole
Cutting length: 20 mm
Oil supply system: Each sample oil was charged into the pilot hole.
Concentration: Metalworking fluid was diluted with water at a concentration of 5 mass %.
Evaluation method: The cutting resistance (in terms of torque [N·m]) was determined. Judgment criteria: The torque of 2.40 N·m or less during cutting operation was evaluated as acceptable (∘).

Test for Anti-Foaming Properties

Evaluation was carried out using 3-L gear pump circulation test method.
Test sample volume: 3 L
Flow rate: 17.4 L/min.
Discharge pressure: 0.6 kgf/cm²
Nozzle diameter: 6.5 mm
Diluent water: Conditioned water containing 5 ppm of calcium
Container: with a diameter of 220 mm and a height of 300 mm
Concentration: Metalworking fluid was diluted with conditioned water (containing 5 ppm of calcium) at a concentration of 5 mass %.
Liquid temperature: 25° C.
Judgment criteria: The absence of overflow of the sample liquid from the container within 30 minutes after initiation of the test was evaluated as acceptable (∘).

### Test for Stability of Stock Solution

The stock solution of metalworking fluid was separately allowed to stand in a thermostatic chamber at −5° C., 25° C., and 50° C. for one week.

∘: Acceptable (A homogeneous state was maintained.)

×: Unacceptable (Turbidity and separation were observed.)

### Test for Emulsion Stability

Immediately after produced, a metalworking fluid was diluted with conditioned hard water (an aqueous solution prepared by diluting 0.0757 g of calcium chloride dihydrate with distilled water up to a total volume of one liter: having a German Hardness of 3° and a Ca hardness of 54 ppm. See Cutting Fluid, Emulsion Stability Test specified in HS K-2221) to have a diluted solution at a concentration of 5 mass %. The obtained solution was visually observed immediately after dilution and 24 hours later. The judgment was made based on the following criteria.

∘: Acceptable (homogeneous solution, without the presence of separation and a milky white layer)

×: Unacceptable (the presence of separation and a milky white layer)

### Test for Resistance to Hydrolysis

After a sample metalworking fluid was allowed to stand in a thermostatic chamber of 50° C. for one week, conditioned hard water (the same as that used in the test for emulsion stability) was used to dilute the metalworking fluid to obtain a diluted solution at a concentration of 5 mass %. The obtained solution was visually observed immediately after dilution and 24 hours later. The judgment was made based on the following criteria.

∘: Acceptable (homogeneous solution, without the presence of separation and a milky white layer)

×: Unacceptable (the presence of separation and a milky white layer)

### Test for Low-Temperature Properties (Kinematic Viscosity at 5° C.) (According to JIS K 2283)

The time taken for a predetermined amount of metalworking fluid to flow through a capillary of the viscometer was measured, and the kinematic viscosity was calculated from the flow time and the viscometer constant. The low-temperature properties were evaluated in terms of the kinematic viscosity at 5° C.

∘: Acceptable (1500 mm²/s or less)

×: Unacceptable (more than 1500 mm²/s)

TABLE 1

| Examples | 1 | 2 | 3 | 4 | 5 | 6 |
|---|---|---|---|---|---|---|
| Base Oil | | | | | | |
| 2-ethylhexyl palmitate | 1 | — | 0.5 | 5 | — | 2.5 |
| 2-ethylhexyl stearate | — | 1 | 0.5 | — | 5 | 2.5 |
| Trimethylolpropane trioleate | — | — | — | — | — | — |
| Pentaerythritol tetraoleate | — | — | — | — | — | — |
| Rapeseed oil | — | — | — | — | — | — |
| Mineral oil (40° C.: 8 mm²/s) | 30 | 30 | 30 | 26 | 26 | 26 |
| Mineral oil (40° C.: 46 mm²/s) | 20 | 20 | 20 | 20 | 20 | 20 |
| Anionic surfactant | | | | | | |
| Amine | | | | | | |
| Monoisopropanolamine | 5 | 5 | 5 | 5 | 5 | 5 |
| Diisopropanolamine | 3 | 3 | 3 | 3 | 3 | 3 |
| Dicyclohexylamine | 5 | 5 | 5 | 5 | 5 | 5 |
| Fatty acid | | | | | | |
| Oleic acid | 5 | 5 | 5 | 5 | 5 | 5 |
| Isostearic acid | 5 | 5 | 5 | 5 | 5 | 5 |
| Ricinoleic acid polycondensate | 16 | 16 | 16 | 16 | 16 | 16 |
| Water | 10 | 10 | 10 | 10 | 10 | 10 |
| Acid value | 25.0 | 25.0 | 25.0 | 25.0 | 25.0 | 25.0 |
| Amine value | 65.5 | 65.5 | 65.5 | 65.5 | 65.5 | 65.5 |
| pH⁽*⁾ | 9.9 | 9.9 | 9.9 | 9.9 | 9.9 | 9.9 |
| Evaluations | | | | | | |
| Cutting resistance (N · m) | 2.39 | 2.38 | 2.39 | 2.36 | 2.35 | 2.35 |
| | ∘ | ∘ | ∘ | ∘ | ∘ | ∘ |
| Anti-foaming properties | ∘ | ∘ | ∘ | ∘ | ∘ | ∘ |
| Stability of stock solution | ∘ | ∘ | ∘ | ∘ | ∘ | ∘ |
| Emulsion stability | ∘ | ∘ | ∘ | ∘ | ∘ | ∘ |
| Resistance to hydrolysis | ∘ | ∘ | ∘ | ∘ | ∘ | ∘ |
| Low-temperature properties | 959 | 967 | 965 | 979 | 976 | 980 |
| (Kinematic viscosity at 5° C.) (mm²/s) | ∘ | ∘ | ∘ | ∘ | ∘ | ∘ |

TABLE 2

| Examples | 7 | 8 | 9 | 10 | 11 | 12 |
|---|---|---|---|---|---|---|
| Base Oil | | | | | | |
| 2-ethylhexyl palmitate | 10 | — | 5 | 15 | — | 7.5 |
| 2-ethylhexyl stearate | — | 10 | 5 | — | 15 | 7.5 |
| Trimethylolpropane trioleate | — | — | — | — | — | — |
| Pentaerythritol tetraoleate | — | — | — | — | — | — |
| Rapeseed oil | — | — | — | — | — | — |
| Mineral oil (40° C.: 8 mm²/s) | 21 | 21 | 21 | 16 | 16 | 16 |
| Mineral oil (40° C.: 46 mm²/s) | 20 | 20 | 20 | 20 | 20 | 20 |
| Anionic surfactant | | | | | | |
| Amine | | | | | | |
| Monoisopropanolamine | 5 | 5 | 5 | 5 | 5 | 5 |
| Diisopropanolamine | 3 | 3 | 3 | 3 | 3 | 3 |
| Dicyclohexylamine | 5 | 5 | 5 | 5 | 5 | 5 |
| Fatty acid | | | | | | |
| Oleic acid | 5 | 5 | 5 | 5 | 5 | 5 |
| Isostearic acid | 5 | 5 | 5 | 5 | 5 | 5 |
| Ricinoleic acid polycondensate | 16 | 16 | 16 | 16 | 16 | 16 |
| Water | 10 | 10 | 10 | 10 | 10 | 10 |
| Acid value | 25.0 | 25.0 | 25.0 | 25.0 | 25.0 | 25.0 |
| Amine value | 65.5 | 65.5 | 65.5 | 65.5 | 65.5 | 65.5 |
| pH⁽*⁾ | 9.9 | 9.9 | 9.9 | 9.9 | 9.9 | 9.9 |
| Evaluations | | | | | | |
| Cutting resistance (N · m) | 2.31 | 2.31 | 2.31 | 2.31 | 2.30 | 2.30 |
| | ∘ | ∘ | ∘ | ∘ | ∘ | ∘ |
| Anti-foaming properties | ∘ | ∘ | ∘ | ∘ | ∘ | ∘ |
| Stability of stock solution | ∘ | ∘ | ∘ | ∘ | ∘ | ∘ |
| Emulsion stability | ∘ | ∘ | ∘ | ∘ | ∘ | ∘ |
| Resistance to hydrolysis | ∘ | ∘ | ∘ | ∘ | ∘ | ∘ |
| Low-temperature properties | 990 | 980 | 985 | 999 | 1000 | 1002 |
| (Kinematic viscosity at 5° C.) (mm²/s) | ∘ | ∘ | ∘ | ∘ | ∘ | ∘ |

TABLE 3

| Examples | 13 | 14 | 15 | 16 | 17 | 18 |
|---|---|---|---|---|---|---|
| Base Oil | | | | | | |
| 2-ethylhexyl palmitate | 0.5 | 0.5 | 2.5 | 2.5 | 7.5 | 7.5 |
| 2-ethylhexyl stearate | 0.5 | 0.5 | 2.5 | 2.5 | 7.5 | 7.5 |
| Trimethylolpropane trioleate | — | — | — | — | — | — |
| Pentaerythritol tetraoleate | — | — | — | — | — | — |
| Rapeseed oil | — | — | — | — | — | — |
| Mineral oil (40° C.: 8 mm²/s) | 40 | 15 | 40 | 15 | 40 | 15 |
| Mineral oil (40° C.: 46 mm²/s) | 39 | 14 | 35 | 10 | 25 | — |
| Anionic surfactant | | | | | | |
| Amine | | | | | | |
| Monoisopropanolamine | 1.5 | 7.5 | 1.5 | 7.5 | 1.5 | 7.5 |
| Diisopropanolamine | 1 | 5 | 1 | 5 | 1 | 5 |
| Dicyclohexylamine | 1.5 | 7.5 | 1.5 | 7.5 | 1.5 | 7.5 |
| Fatty acid | | | | | | |
| Oleic acid | 1.5 | 7.5 | 1.5 | 7.5 | 1.5 | 7.5 |
| Isostearic acid | 1.5 | 7.5 | 1.5 | 7.5 | 1.5 | 7.5 |
| Ricinoleic acid polycondensate | 3 | 25 | 3 | 25 | 3 | 25 |
| Water | 10 | 10 | 10 | 10 | 10 | 10 |
| Acid value | 6.9 | 37.8 | 6.9 | 37.8 | 6.9 | 37.8 |
| Amine value | 20.1 | 100.6 | 20.1 | 100.6 | 20.1 | 100.6 |
| pH⁽*⁾ | 9.7 | 10.0 | 9.7 | 10.0 | 9.7 | 10.0 |
| Evaluations | | | | | | |
| Cutting resistance (N · m) | 2.40 | 2.38 | 2.38 | 2.34 | 2.33 | 2.28 |
| | ∘ | ∘ | ∘ | ∘ | ∘ | ∘ |
| Anti-foaming properties | ∘ | ∘ | ∘ | ∘ | ∘ | ∘ |
| Stability of stock solution | ∘ | ∘ | ∘ | ∘ | ∘ | ∘ |
| Emulsion stability | ∘ | ∘ | ∘ | ∘ | ∘ | ∘ |
| Resistance to hydrolysis | ∘ | ∘ | ∘ | ∘ | ∘ | ∘ |
| Low-temperature properties | 966 | 976 | 980 | 990 | 996 | 1005 |
| (Kinematic viscosity at 5° C.) (mm²/s) | ∘ | ∘ | ∘ | ∘ | ∘ | ∘ |

TABLE 4

| Comparative Examples | 1 | 2 | 3 | 4 | 5 |
|---|---|---|---|---|---|
| Base Oil | | | | | |
| 2-ethylhexyl palmitate | — | — | — | — | — |
| 2-ethylhexyl stearate | — | — | — | — | — |
| n-octyl palmitate | — | 5 | — | — | — |
| Trimethylolpropane trioleate | — | — | 5 | — | — |
| Pentaerythritol tetraoleate | — | — | — | 5 | — |
| Rapeseed oil | — | — | — | — | 5 |
| Mineral oil (40° C.: 8 mm²/s) | 31 | 26 | 26 | 26 | 26 |
| Mineral oil (40° C.: 46 mm²/s) | 20 | 20 | 20 | 20 | 20 |
| Anionic surfactant | | | | | |
| Amine | | | | | |
| Monoisopropanolamine | 5 | 5 | 5 | 5 | 5 |
| Diisopropanolamine | 3 | 3 | 3 | 3 | 3 |
| Monoethanolamine | — | — | — | — | — |
| Diethanolamine | — | — | — | — | — |
| Dicyclohexylamine | 5 | 5 | 5 | 5 | 5 |
| Fatty acid | | | | | |
| Oleic acid | 5 | 5 | 5 | 5 | 5 |
| Isostearic acid | 5 | 5 | 5 | 5 | 5 |
| Ricinoleic acid polycondensate | 16 | 16 | 16 | 16 | 16 |
| Water | 10 | 10 | 10 | 10 | 10 |
| Acid value | 25.0 | 25.0 | 25.0 | 25.0 | 25.0 |
| Amine value | 65.5 | 65.5 | 65.5 | 65.5 | 65.5 |
| pH⁽*⁾ | 9.9 | 9.9 | 9.9 | 9.9 | 9.9 |
| Evaluations | | | | | |
| Cutting resistance (N · m) | 2.48 | 2.34 | 2.44 | 2.44 | 2.44 |
| | x | ∘ | x | x | x |
| Anti-foaming properties | ∘ | ∘ | ∘ | ∘ | ∘ |
| Stability of stock solution | ∘ | ∘ | ∘ | ∘ | ∘ |
| Emulsion stability | ∘ | ∘ | ∘ | ∘ | ∘ |
| Resistance to hydrolysis | ∘ | x | x | x | x |
| Low-temperature properties | 974 | 982 | 983 | 978 | 980 |
| (Kinematic viscosity at 5° C.) (mm²/s) | ∘ | ∘ | ∘ | ∘ | ∘ |

| Comparative Examples | 6 | 7 | 8 | 9 |
|---|---|---|---|---|
| Base Oil | | | | |
| 2-ethylhexyl palmitate | — | 2.5 | 2.5 | 2.5 |
| 2-ethylhexyl stearate | — | 2.5 | 2.5 | 2.5 |
| n-octyl palmitate | — | — | — | — |
| Trimethylolpropane trioleate | — | — | — | — |
| Pentaerythritol tetraoleate | — | — | — | — |
| Rapeseed oil | — | — | — | — |
| Mineral oil (40° C.: 8 mm²/s) | — | 26 | 26 | 26 |
| Mineral oil (40° C.: 46 mm²/s) | 51 | 20 | 20 | 20 |
| Anionic surfactant | | | | |
| Amine | | | | |
| Monoisopropanolamine | 5 | — | 5 | — |
| Diisopropanolamine | 3 | — | 3 | — |
| Monoethanolamine | — | 5 | — | 5 |
| Diethanolamine | — | 3 | — | 3 |
| Dicyclohexylamine | 5 | 5 | 5 | 5 |
| Fatty acid | | | | |
| Oleic acid | 5 | 10 | 10 | 5 |
| Isostearic acid | 5 | — | — | 5 |
| Ricinoleic acid polycondensate | 16 | 16 | 16 | 16 |
| Water | 10 | 10 | 10 | 10 |
| Acid value | 25.0 | 25.0 | 25.0 | 25.0 |
| Amine value | 65.5 | 77.6 | 65.5 | 77.6 |
| pH⁽*⁾ | 9.9 | 9.9 | 9.9 | 9.9 |
| Evaluations | | | | |
| Cutting resistance (N · m) | 2.39 | 2.36 | 2.36 | 2.36 |
| | ∘ | ∘ | ∘ | ∘ |
| Anti-foaming properties | ∘ | x | x | x |
| Stability of stock solution | ∘ | ∘ | ∘ | ∘ |
| Emulsion stability | ∘ | ∘ | ∘ | ∘ |
| Resistance to hydrolysis | ∘ | ∘ | ∘ | ∘ |
| Low-temperature properties | 2002 | 982 | 980 | 983 |
| (Kinematic viscosity at 5° C.) (mm²/s) | x | ∘ | ∘ | ∘ |

⁽*⁾The pH value was measured after diluting the stock solution with pure water at a concentration of 3 mass %.

The metalworking fluids of Examples 1 to 18 according to the invention where the base oil comprises palmitic acid ester with 2-ethyhexanol or stearic acid ester with 2-ethylhexanol, and the anionic surfactant comprises a particular aliphatic carboxylic acid amine salt are excellent in the cutting performance, anti-foaming properties, stability of stock solution, emulsion stability and resistance to hydrolysis, and in addition, show low kinematic viscosities at a low temperature.

The fluid of Comparative Example 1 where neither palmitic acid ester with 2-ethyhexanol nor stearic acid ester with 2-ethylhexanol is contained is inferior in the cutting performance.

The fluid of Comparative Example 2 where n-octyl palmitate is used instead of palmitic acid ester with 2-ethyhexanol or stearic acid ester with 2-ethylhexanol is inferior in the resistance to hydrolysis.

The fluids of Comparative Examples 3 to 5 where trimethylolpropane trioleate, pentaerythritol tetraoleate and rapeseed oil are respectively used instead of palmitic acid ester with 2-ethyhexanol or stearic acid ester with 2-ethylhexanol are inferior in the cutting performance and the resistance to hydrolysis.

The fluid of Comparative Example 6 where neither palmitic acid ester with 2-ethyhexanol nor stearic acid ester with 2-ethylhexanol is contained shows a high kinematic viscosity.

The fluids of Comparative Examples 7 to 9 not containing at least one of the branched aliphatic carboxylic acid with 8 to 18 carbon atoms or the branched alkanolamine with 3 to 12 carbon atoms are inferior in the anti-foaming properties.

1. A metalworking fluid comprising a base oil and an anionic surfactant, wherein
the base oil comprises an aliphatic carboxylic acid ester with 2-ethylhexanol, and the aliphatic carboxylic acid is at least one selected from the group consisting of palmitic acid and stearic acid; and
the anionic surfactant is an aliphatic carboxylic acid amine salt, and the aliphatic carboxylic acid for constituting the aliphatic carboxylic acid amine salt comprises at least one selected from branched aliphatic carboxylic acids having 8 to 18 carbon atoms, and the amine for constituting the aliphatic carboxylic acid amine salt comprises at least one selected from branched alkanolamines having 3 to 12 carbon atoms.

2. The metalworking fluid of claim 1, wherein the aliphatic carboxylic acid ester with 2-ethylhexanol is contained in an amount of 0.5 to 15 mass % in the fluid.

3. The metalworking fluid of claim 1, wherein the anionic surfactant is contained in an amount of 0.05 to 80 mass % in the fluid.

4. The metalworking fluid of claim 1, which is used as a stock solution or used after diluted with water at a concentration of 0.1 mass % or more.

5. The metalworking fluid of claim 1, which is a cutting oil or grinding oil.

6. A metal working method for processing metals, comprising using the metalworking fluid of claim 1.

7. The metal working method of claim 6, which is for cutting or grinding.

8. A metal work product obtainable by the metal working method of claim 6.
